(19) United States
(12) Patent Application Publication
(10) Pub. No.: US 2026/0192861 A1
(43) Pub. Date: Jul. 9, 2026

(54) REINFORCING BRACKET FOR A VEHICLE TUNNEL

(71) Applicant: STELLANTIS AUTO SAS, Poissy (FR)

(72) Inventors: Said EL FAKKOUSSI, Fes (MA); Damien BESSETTE, Ecot (FR); Sebastien MEURANT, Argiesans (FR)

(21) Appl. No.: 19/133,208

(22) PCT Filed: Nov. 20, 2023
(86) PCT No.: PCT/FR2023/051820

§ 371 Date: May 27, 2025

(30) Foreign Application Priority Data
Dec. 20, 2022 (FR) 2213900

(51) Int. Cl. B62D 25/20; B62D 29/00

(52) U.S. Cl. CPC B62D 25/20; B62D 29/00

(57) ABSTRACT

The invention relates to a reinforcing bracket for a vehicle tunnel positioned at a front seat crossmember (4), characterized in that the bracket (1) comprises at least two reinforcing elements and at least one connecting element, each reinforcing element comprising a main face comprising a transverse portion and two branches, and at least two lateral sides projecting from each branch, the at least one connecting element comprising a planar face and at least two lateral sides projecting from either side of the planar face, the at least one connecting element being configured to be positioned between the at least two reinforcing elements, the connecting element making it possible to maintain the at least two reinforcing elements substantially opposite one another.

### CROSS-REFERENCE TO RELATED APPLICATIONS

This application is the US National Stage under 35 USC § 371 of International Application No. PCT/FR2023/051820, filed Nov. 20, 2023, which claims the priority of French application 2213900 filed on Dec. 20, 2022, the content (text, drawings and claims) of both said applications being incorporated by reference herein.

### BACKGROUND

The described devices relate to a reinforcing bracket for a vehicle transmission tunnel.

Following the removal of the aluminum side member and during an impact with a post at a 75° angle at a speed of 32 km/h, problems were identified with the structural integrity of the underbody, particularly between the tunnel and the floor on the side of the front seat crossmember of the vehicle. A large opening and detachment of the weld spots were detected, creating an imbalance in the underbody. The inside of the tunnel in the part connected to the front seat crossmember then exhibits a weakness.

We therefore propose at least one solution to overcome this drawback.

### SUMMARY

To this end, related herein is a reinforcing bracket for a vehicle transmission tunnel. The bracket comprises at least two reinforcing elements and at least one connecting element connecting the at least two reinforcing elements, each reinforcing element comprising a substantially U-shaped main face and at least two lateral sides, the main face comprising a transverse portion and two branches, the at least two lateral sides projecting from each branch, the at least one connecting element comprising a planar face and at least two lateral sides projecting from either side of said planar face, the at least one connecting element being configured to be positioned between the at least two reinforcing elements, the at least two sides of the connecting element bearing on the two main faces of the at least two reinforcing elements at the transverse portions, the connecting element making it possible to maintain the at least two reinforcing elements substantially opposite one another.

In order to optimize mass, the aluminum profile of the side member, which is used for impact protection according to the American homologation—identical to the European one—for internal combustion engine vehicles, has been removed. The described devices preserve the structural integrity of the underbody in the event of a side impact by a vehicle with a post at a 75° angle at 32 km/h, for example without an aluminum profile. The aim is therefore to reinforce the tunnel by adding a bracket. The described devices reinforce the inside of the tunnel in the area connected to a front seat crossmember and distributing the forces between the heel board, the seat crossmember and the A-pillar. To solve this problem, a bracket is added in the area with a functional clearance of 25 mm between the muffler and the tunnel. This solution corrects the problem of the opening between the tunnel and the floor, and also corrects the problem of the detachment of the weld spots in this area. The described devices provide improved structural behavior of the underbody. The describe devices also offer considerable savings in terms of manufacturing cost and weight, as the aluminum profile in the side member is eliminated. The bracket is positioned between the front seat crossmembers and contributes to resistance to deformation in the event of a side impact.

Each reinforcing element can have a height of 134 mm.

Each reinforcing element can have a length of 164 mm.

Each reinforcing element can have a thickness of 2 mm.

Each reinforcing element can be made of DP980.

Each connecting element can be made of DP1180.

Also related herein is a vehicle transmission tunnel comprising at least one bracket.

Also related herein is a motor vehicle comprising at least one tunnel.

### BRIEF DESCRIPTION OF THE FIGURES

Further features and advantages of the described devices will become clearer from the description exemplified by the appended drawings, in which:

FIG. 1 shows a general view of a bracket positioned in a tunnel,

FIG. 2 shows a front and rear view of a reinforcing element,

FIG. 3 shows a general view of a connecting element,

FIG. 4 shows two different views of a bracket,

FIG. 5 shows the attachment points with the tunnel of a bracket.

### DETAILED DESCRIPTION

As these embodiments are by no means limiting, variants comprising only a selection of features described or shown hereinafter in isolation from the other features described or shown (even if this selection is isolated within a sentence comprising these other features) may be considered, if this selection of features is sufficient to confer a technical advantage or to differentiate the described devices from the prior art. This selection comprises at least one preferably functional feature without structural details, and/or with only part of the structural details if this part alone is sufficient to confer a technical advantage or to differentiate the described devices from the prior art.

In the description that follows, the terms “lower”, “upper”, “top”, “bottom”, etc. are used in reference to the drawings for ease of understanding. They are not to be understood as limitations on the scope.

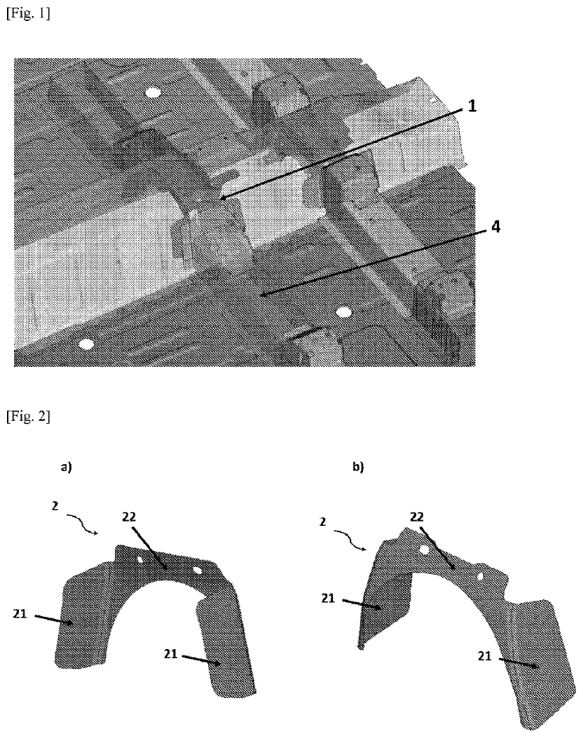

With reference to FIG. 1, a general view of a bracket positioned in a vehicle transmission tunnel will first be described. FIG. 1 shows the bracket 1 positioned between two parts of a front seat crossmember 4. The bracket 1 comprises two parts: reinforcing elements 2 and a connecting element 3. FIG. 2 shows a front and rear view of a reinforcing element 2. Each reinforcing element 2 comprises a substantially planar or slightly curved main face 22 and two lateral sides 21. The face 22 is substantially U-shaped and comprises a transverse portion and two branches. The transverse portion links the two branches. The two lateral sides 21 project from each of the branches. The face 22 comprises a tongue-like extension with two openings at the transverse portion. Both openings are intended for stamping or for manufacturing constraints. The planar face 22, or more precisely its transverse portion, has a functional clearance of 25 mm with the tunnel when the bracket is in position.

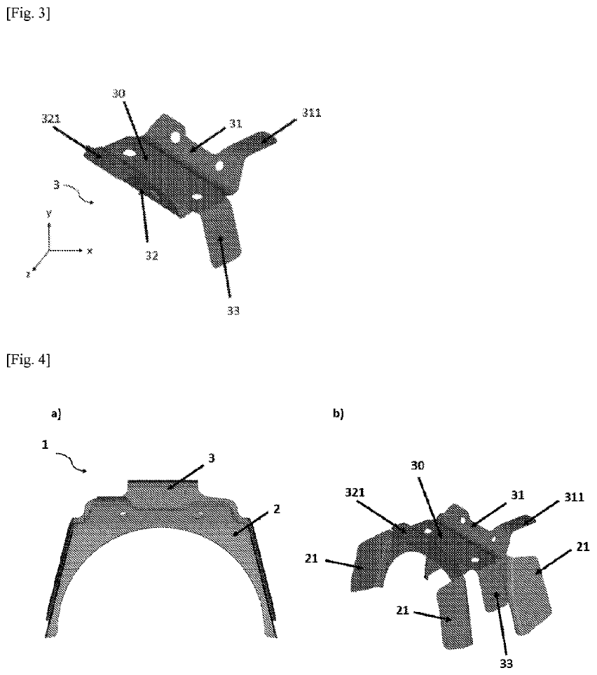

FIG. 3 shows a general view of a connecting element. Each connecting element 3 comprises a planar face 30 and at least two lateral sides 31 and 32. The connecting element also comprises two additional lateral sides 33 (one of the additional sides is not visible in FIG. 3). The planar face 30 has a substantially rectangular shape and comprises two openings. Both openings are intended for stamping or for manufacturing constraints. The at least two lateral sides 31 and 32 project in a direction y (upwards) from the planar face 30 at an angle of between 20 and 90 degrees. Preferably, the lateral sides 31 and 32 are inclined outwards from the planar face 30. The lateral side 31 comprises two openings and a tongue 311 folded back relative to the lateral side 31 so as to be substantially parallel to the planar face 30. The tongue 311 is not centered with respect to the center of the planar face 30. The lateral side 32, opposite the lateral side 31, also comprises two openings and a tongue 321 folded back relative to the lateral side 32 so as to be substantially parallel to the planar face 30. The tongue 321 is centered with respect to the center of the planar face 30. The tongue 311 is longer than it is wide, while the tongue 321 is wider than it is long. The two additional lateral sides 33, opposite one another and located across the width of the planar face 30, project in a direction-y (downwards) from the planar face 30 at an angle of between 20 and 90 degrees. Preferably, the lateral sides 33 are inclined outwards from the planar face 30. The lateral sides 33 correspond to a tongue that is longer than it is wide.

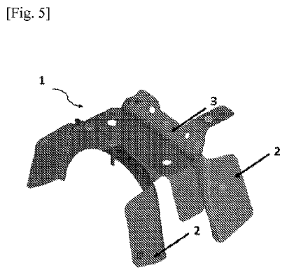

FIG. 4 shows two different views of a bracket. Two reinforcing elements 2 are positioned face to face. A connecting element 3 is positioned on the two reinforcing elements 2 at their transverse portions. The connecting element 3 has a shape complementary to the space created between two reinforcing elements 2. Preferably, the distance between two reinforcing elements is 73 mm. The two reinforcing elements are positioned back to back. The openings of the reinforcing elements 2 are then superimposed on the openings of the connecting element 3 when said connecting element is in position. As shown in FIG. 1, the tunnel rests on the lateral sides 33 and on the tongues 311 and 321 when mounted on the bracket. The front seat crossmember is then attached to the tunnel. The tunnel is attached to the bracket via weld spots as shown in FIG. 5.

In other embodiments, the bracket may, for example, comprise three reinforcing elements and two connecting elements. The number of elements of the bracket can be adapted to suit specific requirements and/or the vehicle type. The number of connecting elements is always equal to N−I, where N is the number of reinforcing elements.

Of course, the described devices are not limited to the examples that have just been described and numerous modifications could be made to these examples without departing from the scope. Of course, the different features, shapes, variants and embodiments could be associated together according to various combinations to the extent that they are not incompatible or exclusive of one another. In particular, all of the previously described variants and embodiments may be combined together.

1. A reinforcing bracket for a vehicle transmission tunnel, characterized in that said bracket comprises at least two reinforcing elements and at least one connecting element connecting the at least two reinforcing elements,
each reinforcing element comprising a substantially U-shaped main face and at least two lateral sides, the main face comprising a transverse portion and two branches, the at least two lateral sides projecting from each branch,
the at least one connecting element comprising a planar face and at least two lateral sides projecting from either side of said planar face, the at least one connecting element being configured to be positioned between the at least two reinforcing elements, the at least two sides of the connecting element bearing on the two main faces of the at least two reinforcing elements at the transverse portions, the connecting element making it possible to maintain the at least two reinforcing elements substantially opposite one another.

2. The reinforcing bracket according to claim 1, wherein each reinforcing element has a height of 134 mm.

3. The reinforcing bracket according to claim 1, wherein each reinforcing element has a length of 164 mm.

4. The reinforcing bracket according to claim 1, wherein each reinforcing element has a thickness of 2 mm.

5. The reinforcing bracket according to claim 1, wherein each reinforcing element is made of DP980.

6. The reinforcing bracket according to claim 1, wherein each connecting element is made of DP1180.

7. A vehicle transmission tunnel comprising at least one bracket according to claim 1.

8. A motor vehicle comprising at least one vehicle transmission tunnel according to claim 7.
